(19) United States
(12) Patent Application Publication
(10) Pub. No.: US 2009/0149173 A1
(43) Pub. Date: Jun. 11, 2009

(54) WIRELESS NETWORK PROFILING SYSTEM

(75) Inventor: Michael Tolaio, Scotts Valley, CA (US)

Correspondence Address: LAW OFFICES OF MIKIO ISHIMARU, 333 W. EL CAMINO REAL, SUITE 330, SUNNYVALE, CA, 94087, US

(73) Assignee: Sunrise Telecom Incorporated, San Jose, CA (US)

(21) Appl. No.: 11/382,479

(22) Filed: May 9, 2006

(51) Int. Cl. H04W 24/00

(52) U.S. Cl. 455/424

(57) ABSTRACT

A wireless network profiling system is provided including providing a base station tester for attaching to a cellular base station, using a global positioning system for logging the position information of the cellular base station, using the base station tester for collecting a parametric information from the cellular base station and using a mobile handset emulator for transferring the parametric information and position information for analysis and storage.

### TECHNICAL FIELD

The present invention relates generally to wireless communication, and more particularly to a system for testing cellular telephone base stations.

### BACKGROUND ART

Telecommunications equipment traditionally has been offered with a significant number of features allowing on-line system test and operational maintenance surveillance. These features allow economical system operation, administration and maintenance (OA&M) since routine system testing and monitoring must be performed on the base station and any remote antennas. A number of tests must be performed and service provider technical staff must carry and maintain numerous pieces of test equipment in order to address these tasks.

During and after initial installation of a telecommunications system, determining the integrity of a base station antenna is an important concern. The receive antenna return loss test is a diagnostic measurement routinely performed with various cellular base station products, which provides a reasonable verification of sustained antenna integrity. This test quantifies the reflection characteristics of an antenna in order to detect whether the antenna is functioning within desired parameters. The ratio of radio frequency (RF) power reflected from the antenna to the RF power applied to the antenna defines the reflection coefficient of the antenna. A reflection coefficient having a value close to zero (0) indicates that very little RF power is reflected and that the antenna is functioning properly. A reflection coefficient having a value close to one (1) indicates that most of the RF power is reflected and that the antenna is transmitting virtually zero RF power. Transmission of very low RF power indicates problems with the antenna or the cabling between the antenna transmitter, receiver, and the cellular base station, known as the backhaul.

Network analyzers measure the antenna return loss of a cellular base station antenna by injecting a swept signal covering the antenna transmit and/or receive frequencies into the device under test (DUT), i.e., antenna, and measuring the magnitude and phase of the signal that is reflected back. For example, typically, a technician connects the network analyzer to the feeder cable extending between the antenna and the base station, and injects a signal into the feeder cable. If there are any discontinuities in the feeder cable or antenna, part of the signal may be reflected back down the feeder cable to the network analyzer.

Network analyzers are primarily utilized when the antenna being tested is not currently in use. However, if a “live” (i.e., currently in-use) test is required, the injected signal has the potential to disrupt the existing radio links between the base station and customers' mobile phones. For example, when testing a receive antenna (i.e., an antenna operating at the base station receive frequencies), as the network analyzer's source sweeps through the channel that the mobile phone's transmitter occupies (i.e., up-link channel from the mobile phone to the base station), a high level of interference is experienced at the input to the base station receiver. The interference could result in a reduction of the call quality, and possibly cause the call to drop.

In analog systems, the receive antenna return loss test is performed by applying a signal from a radio test unit (RTU) in the mobile receive band and monitoring the signal of a selected receive radio that is assigned to the selected channel frequency. A directional coupler is used to allow measurement of signal energy in both the forward direction and reverse direction, and a switch matrix, that is program controlled, selects the desired direction. The power difference between the forward and reverse signal levels is a measure of the return loss or impedance match accuracy of the antenna system. The forward and reverse signals levels are measured by querying the selected receive radio for it's “receive signal strength indicator” (RSSI) output.

Many of the newer cellular base stations communicate with transmit and receive antennas by using digital transmissions through a copper or optical fiber interface. The interface connecting the mobile switching center to the cellular base station is called the backhaul. The communication across the backhaul can be one of many different protocols, such as T1/E1, T3, ATM, SONET, or a similar communication protocol. In order to verify the performance and general condition of the overall cellular system, these protocols must be monitored and interpreted.

Additionally, most antenna customers want to know the antenna return loss over the entire transmit frequency band to make an informed decision about the status of the antenna (e.g., return loss degradations at only some of the frequencies may indicate a slowly degrading antenna that is destined to fail and should be replaced). However, by using the base station transmitter as the source, transmitted and reflected signal measurements can only be made on the frequencies at which the base station is actually transmitting. Furthermore, without a broadband return loss measurement, the time-domain impulse response of the transmit antenna cannot be accurately calculated. The time-domain impulse response is used by time-domain reflectometry (TDR) to locate the physical position of breaks in the antenna cable. To be effective, TDR requires a broad frequency sweep.

Thus, a need still remains for an efficient network profiling system that can analyze cellular base stations and antennas simply and quickly. In view of the increasing demand for voice and data communications, it is increasingly critical that answers be found to these problems. Another aspect driving change is the ever-increasing need to save costs and improve efficiencies, makes it more and more critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides a wireless network profiling system including providing a base station tester for attaching to a cellular base station, using a global positioning system for logging the position information of the cellular base station, using the base station tester for collecting a parametric information from the cellular base station and using a mobile handset emulator for transferring the parametric information and position information for analysis and storage.

Certain embodiments of the invention have other aspects in addition to or in place of those mentioned or are obvious from the above. The aspects will become apparent to those skilled in the art from a reading of the following detailed description when taken with reference to the accompanying drawings.

### BRIEF DESCRIPTION OF THE DRAWINGS

FIG. 1 is a diagram of a wireless network profiling system in an embodiment of the present invention;

FIG. 2 is a functional block diagram of the base station tester, as shown in FIG. 1; and

FIG. 3 is a flow chart of a wireless network profiling system for the manufacture of the wireless network profiling system, in an embodiment of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGs.

The term “horizontal” as used herein is defined as a plane parallel to the conventional plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements.

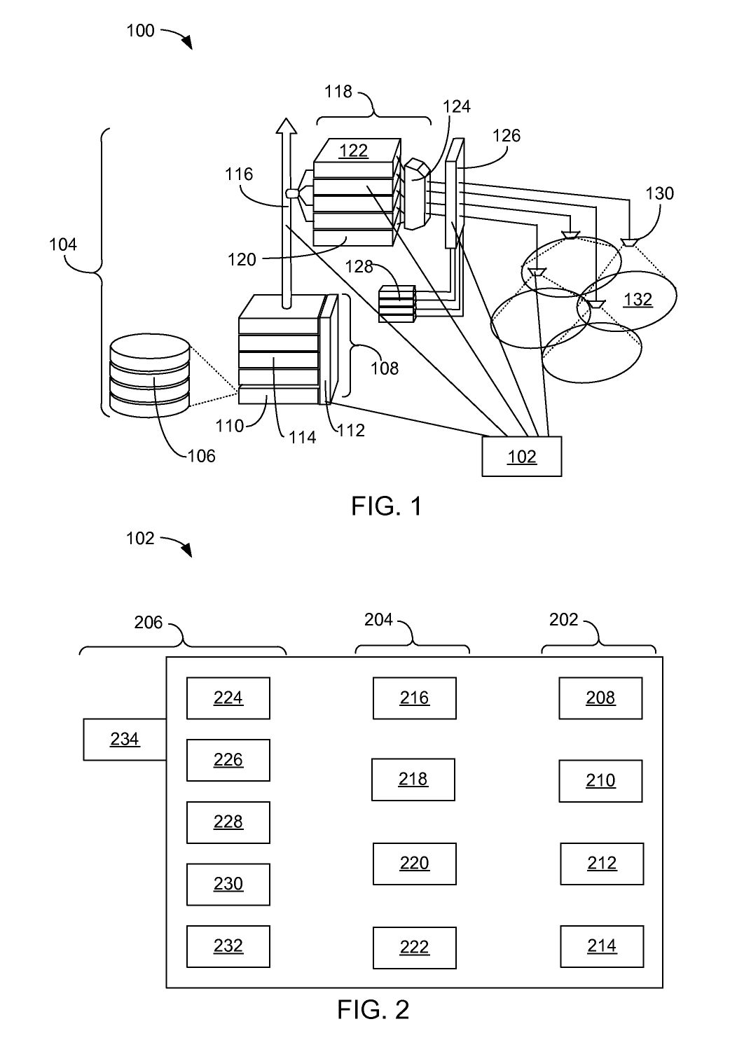

Referring now to FIG. 1, therein is shown a diagram of a wireless network profiling system 100 in an embodiment of the present invention. The diagram depicts the wireless network profiling system 100 having a base station tester 102, attached to five analysis points within a cellular base station 104. These connection points are for example only and the actual number and location of the connection to the cellular network profiling system 100 may be in a physically different location or by linking radio frequency (RF) signals without a physical connection allowing a non-invasive sampling. The cellular base station 104 supports multiple communication functions 106, such as public safety, paging, cellular service, two way communication and telemetry, received from a mobile switching center (MSC) (not shown). The multiple communication functions 106 enter a base station head-end 108 through a radio interface unit 110, which supplies bidirectional communication for the multiple communication functions 106.

Testing of the cellular base station 104 can be performed under a variety of circumstances at the cell site, including acceptance testing during a new installation, out-of-service testing, and in-service maintenance. During acceptance testing and in-service maintenance it is highly desirable that the cellular base station 104 be operating under normal conditions.

The base station head-end 108 comprises the radio interface unit 110, a base station controller 112, and multiple instances of a base station transceiver 114. A backhaul 116, such as a T1, E1, T3, E3, ATM or optical transport, connects the base station head-end 108 to a remote hub 118. The remote hub 118 includes a packet controller 120, several of a communication encoder/decoder 122 and a bi-directional buffer 124. The remote hub 118 performs encoding of packet information for transmission to the appropriate communication service, such as paging, cellular communication, telemetry, or two-way radio communication. When a return signal comes from the bi-directional buffer 124, the protocol, such as cdmaOne, CDMA2000, W-CDMA (UMTS), GSM, TDMA or AMPS, is decoded by the communication encoder/decoder 122. The bi-directional buffer 124 is connected to a Wi-Fi access control device 126.

The Wi-Fi access control device 126 controls the signal distribution to a wireless access point 128, a passive broadband antenna 130, or a combination thereof. The wireless access point would usually be used in an indoor location with limited range. The passive broadband antenna 130 is usually used in an outdoor location where wireless coverage is spread over a wide area. The passive broadband antenna 130 has a coverage area 132. By strategically placing several of the passive broadband antenna 130 large areas, up to several square miles, can be serviced by the cellular network.

The base station tester 102 has the ability to sample and diagnose the signals at several of the key points in the wireless network profiling system 100. Radio frequency (RF) signals may be non-intrusively sampled at the passive broadband antenna 130 or the wireless access point 128. The RF signal is monitored for output power, frequency of the transmission, and distinct operation of the individual channels. The base station tester 102 has the ability to emulate a wireless handset in order to verify the receiving capabilities of both the passive broadband antenna 130 and the wireless access point 128. The base station tester 102 may attach directly to the Wi-Fi access control device 126 to verify the proper operation of the cellular access controls.

The base station tester 102 may attach directly to the remote hub 118 in order to monitor the frequency of operation and proper encoding and decoding of the packets being transferred. The internal circuitry of the base station tester 102 decodes the received signals and verifies that the communication encoder/decoder 122 is operating correctly. The base station tester 102 can identify any weakness in the remote hub 118. It is important to the operation of the wireless network profiling system 100 that any issues are addressed prior to a complete failure of the network.

The backhaul 116 may be analyzed by the base station tester 102. The condition of the backhaul 116 material can be analyzed by attaching the base station tester 102 to the backhaul 116. The backhaul 116 may be copper coax based or it may be optical fiber. In either case the base station tester 102 is capable of detecting the condition of the material, measuring the power of the communication and decoding the content.

The base station controller 112 may be connected to a mobile switching center (not shown) through the radio interface unit 110. This connection may be made through an optical fiber interface, or copper cabling. The communication path consists of one or more bi-directional, high-speed data lines that incorporate a control channel and a voice channel. The base station tester 102 may be used to verify the integrity of the connection to the mobile switching center (not shown). Measurements can be made of the received signals and the processing time within the base station head-end 108.

Referring now to FIG. 2, therein is shown a functional block diagram of the base station tester 102. The functional block diagram depicts the base station tester 102 having three functional groups comprising a user interface 202, a measure and control group 204, and a tester interface 206. The functional aspect of the grouping is not intended to limit or define the implementation of the individual circuits.

The user interface 202 comprises the functions available to the operator (not shown) of the base station tester 102. A graphical user interface 208 presents tester options, based on the hardware configuration, and displays graphical results of tests performed. A display driver 210 works in conjunction with the graphical user interface 208 to configure touch screen selection of tester options. A push button interface 212 is used for power on/off, cursor placement, file management, volume control, tester reset, and test initiation. A report generator 214 compiles information indicating test parameters, test results, global position during the test, and operator notes for future reference or analysis.

The measure and control group 204 comprises a digital signal processor 216 (DSP), a protocol analysis block 218, a global positioning system 220, and a mobile handset emulator 222. The digital signal processor 216 may be a single processor or a set of processors that enable the operation of the base station tester 102. The digital signal processor 216 may compare performance information against pre-loaded or user defined limits. The protocol analysis block 218, which works in conjunction with the digital signal processor 216 to identify and interpret communication details, is capable of interpreting protocols in RF, optical fiber, and backhaul communication. The RF protocols that may be interpreted include CDMA, W-CDMA (UMTS), and GSM. The optical fiber and backhaul communication includes T1/T3, E1/E3, OC3, among others.

The global positioning system 220 is used to identify the absolute position that the tester was in during the execution of a test. This feature becomes important if the base station tester 102 is used for field verification of multiple base station and antenna systems that form the cellular network profiling system 100. These systems must constantly be monitored to guarantee their continued operation to support service standards established with the users of the wireless network profiling system 100. The mobile handset emulator 222 is used to test the receive function of the wireless access point 128, of FIG. 1, and the passive broadband antenna 130, of FIG. 1. The mobile handset emulator 222 also allows the operator (not shown) to transfer voice and data information, through the wireless network profiling system 100, for storage or immediate analysis.

The tester interface 206 comprises an RF power monitor 224, a spectrum analyzer 226, a network analyzer 228, a cable analyzer 230, such as a signal generator, and an optical analyzer 232. The RF power monitor 224 is used with a peripheral antenna (not shown) to measure the transmitted RF signal from the wireless access point 128, of FIG. 1, and the passive broadband antenna 130, of FIG. 1. By capturing the power spectrum of the wireless access point 128, of FIG. 1, or the passive broadband antenna 130, of FIG. 1, at a known position relative to the transmitter, a good indication of their performance is possible. The RF power monitor 224 works in conjunction with the digital signal processor 216 to verify the transmitter is operating within expected parameters. For example, in the case of code division multiplex access (CDMA) according to the EIA IS-95 standard may contain up to 64 channels at different power levels. The base station tester 102 can perform a good/bad comparison of the transmitted signal or it can collect a detailed spectrum of the RF power for later comparison. This feature allows detection of degradation in the transmission path over time.

The spectrum analyzer 226 performs a frequency analysis of the transmitted signal from the wireless access point 128, of FIG. 1, and the passive broadband antenna 130, of FIG. 1. The spectrum analyzer 226 captures frequency peaks and distribution present in the media being analyzed. This function can be used for RF analysis as well as the backhaul 116 and optical fiber analysis. The frequencies in the transmission and receive protocols are well defined, so the base station tester 102 can detect possible degradation before a complete system failure occurs. The spectrum analyzer 226 can also be used to capture a current snapshot of the frequency performance of key components in the cellular network profiling system 100, which may be compared against previous samples for trend analysis. A trend analysis of a series of parametric information may identify a weak component prior to failure of the cellular base station 104.

The network analyzer 228 working with the digital signal processor 216 and the protocol analysis block 218 may capture and interpret the communication across the media being tested, such as the backhaul 116, of FIG. 1 or the RF energy exchanged through the wireless access point 128, of FIG. 1, or the passive broadband antenna 130, of FIG. 1. The network analyzer 228 keeps track of individual data threads sent across the media in order to display a complete picture of the performance of exchanges across the media being tested. If a series of errors are detected on the media being tested a further analysis of the media being tested can be performed by using one of the additional functions available in the base station tester 102.

The cable analyzer 230 is available to verify the integrity of the broadband RF coaxial cable, in the event that the broadband RF coaxial cable is a metal media, such as copper. The cable analyzer 230 sends a burst of RF energy into the metal media, such as copper, and monitors the media for any reflected energy. If very little RF energy is reflected, the metal media, such as copper, is operating correctly and there is no damage. If a large amount of RF energy is returned, the metal media, such as copper, is damaged somewhere along its path. The cable analyzer 230 may use a technique know as frequency domain reflectometry to determine how far away from the source the damage is located. This operation is performed by timing the interval between the transmission of the RF energy into the metal media, such as copper, and the return of the reflection from the damaged area. The standard cable and antenna system measurements include return loss, one-port cable insertion loss, and fault location.

By capturing the amount of energy that is returned, an indication of the type of damage can be predicted. A small amount of reflected RF energy can indicate that the insulation on the metal media, such as copper, has been damaged, while a near total reflection of the transmitted RF energy would indicate that the metal media, such as copper, is severed somewhere along the path. The timing of the reflection is an indication of the distance from the base station tester 102, of FIG. 1, to the damaged area.

The base station tester 102, of FIG. 1, is also capable of analyzing the backhaul 116, of FIG. 1, implemented as a fiber optic link. In this mode the optical analyzer 232 is utilized to check the received optical energy for frequency dispersion or lack of intensity. Either of these conditions could indicate that the optical fiber is damaged. By linking the optical analyzer 232 with the digital signal processor 216 and the protocol analysis block 218, the backhaul 116, of FIG. 1, content can be decoded and analyzed. The coordination of the resources of the base station tester provides a complete view of the operation of the wireless network profiling system 100, of FIG. 1, from commands arriving through the radio interface unit 110, of FIG. 1, through to RF energy transmitted through the passive broadband antenna 130, of FIG. 1.

The same type of monitoring can be performed through the receive path. In this case, the base station tester 102, of FIG. 1, may operate as the mobile handset emulator 222 to send RF energy into the passive broadband antenna 130, of FIG. 1, and eventually monitor that information transferred through the radio interface unit 110, of FIG. 1, between the cellular base station 104, of FIG. 1, and the mobile switching center (not shown).

An RF antenna 234 is optionally attached to the base station tester 102 in order to sample transmitted frequencies. The RF antenna 234 when used in conjunction with the digital signal processor 216 and the RF power monitor 224, can be used to verify the parametric support for industry specifications, such as the CDMA IS-95 standard which may contain up to 64 channels at different power levels. The RF antenna 234 can be used with the network analyzer 228, the digital signal processor 216, and the protocol analysis block 218 in order to capture traces of the exchanges between the cellular base station 104, of FIG. 1, and mobile users (not shown).

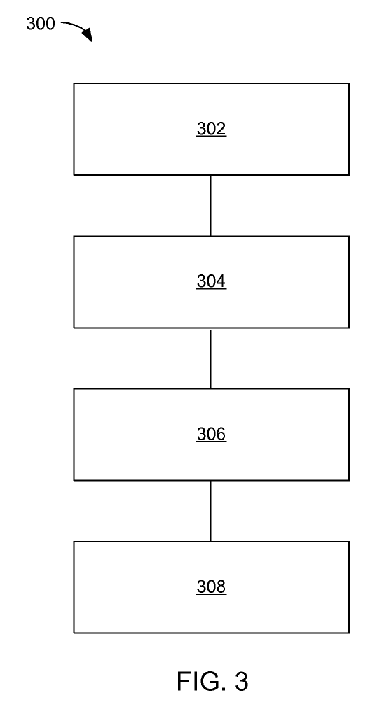

Referring now to FIG. 3, therein is shown a flow chart of a wireless network profiling system 300 for manufacture of a wireless network profiling system in accordance with an embodiment of the present invention. The system 300 includes providing a base station tester for attaching to a cellular base station in a block 302; using a global positioning system for logging the position information of the cellular base station in a block 304; using the base station tester for collecting a parametric information from the cellular base station in a block 306; and using a mobile handset emulator for transferring the parametric information and position information for analysis and storage in a block 308.

In greater detail, a method to manufacture a wireless network profiling system, in an embodiment of the present invention, is performed as follows:
1. Providing a base station tester for attaching to a cellular base station including a passive broadband antenna or a wireless access point. (FIG. 1)
2. Using a global positioning system for logging the position information of the cellular base station, the passive broadband antenna, or the wireless access point. (FIG. 1)
3. Using the base station tester for collecting parametric information from the cellular base station. (FIG. 1) and
4. using a mobile handset emulator for transferring the parametric information and position information for analysis and storage allowing immediate delivery of tester status and trend analysis of previously stored tester status for the base station tester location. (FIG. 1)

It has been discovered that the present invention thus has numerous aspects.

It has been discovered that combination of several analysis techniques within the base station tester enables rapid analysis of any wireless communication network issues. Capturing the performance parameters of the cellular communication network allows a unique trend analysis to be performed on the network components supporting the cellular network profiling system.

An aspect is that the present invention enables the rapid transmission of parametric information to an alternate site for analysis or storage. The comparison of a series of measurements from the same site can be compared for variations in the power or frequency spectrums that could predict equipment failure.

Another aspect is that the inclusion of a global positioning system chip within the base station tester allows correlation of detailed parametric information based on position of the tester relative to the passive broadband antenna.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the wireless network profiling system method and apparatus of the present invention furnish important and heretofore unknown and unavailable solutions, capabilities, and functional aspects for analyzing and maintaining cellular communication networks. The resulting processes and configurations are straightforward, cost-effective, uncomplicated, highly versatile and effective, can be implemented by adapting known technologies, and are thus readily suited for efficiently and economically manufacturing base station test devices fully compatible with conventional manufacturing processes and technologies. While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

What is claimed is:

1. A wireless network profiling system comprising:
providing a base station tester for attaching to a cellular base station;
using a global positioning system for logging the position information of the cellular base station;
using the base station tester for collecting a parametric information from the cellular base station; and
using a mobile handset emulator for transferring the parametric information and position information for analysis and storage.

2. The system as claimed in claim 1 further comprising providing a spectrum analyzer for analyzing a frequency spectrum.

3. The system as claimed in claim 1 further comprising providing a digital signal processor for analyzing the parametric information based on preset or user defined limits.

4. The system as claimed in claim 1 further comprising providing a network analyzer working in conjunction with a digital signal processor, and a protocol analysis block for demodulating input signal information.

5. The system as claimed in claim 1 further comprising sampling an RF signal from a passive broadband antenna, attached to the cellular base station, in a non-invasive manner.

6. A wireless network profiling system comprising:
providing a base station tester for attaching to a cellular base station including a passive broadband antenna or a wireless access point;
using a global positioning system for logging the position information of the cellular base station, the passive broadband antenna, or the wireless access point;
using the base station tester for collecting a parametric information from the cellular base station; and
using a mobile handset emulator for transferring the parametric information and position information for analysis and storage allowing immediate delivery of tester status and trend analysis of previously stored tester status for the base station tester location.

7. The system as claimed in claim 6 further comprising providing a spectrum analyzer for analyzing a frequency spectrum, wherein using the spectrum analyzer for frequency analysis of the cellular base station data and commands.

8. The system as claimed in claim 6 further comprising:
providing a digital signal processor for analyzing the parametric information based on preset or user defined limits;
providing an RF power monitor allowing monitoring of interconnect and transmit power levels; and
providing an RF antenna, attached to the base station tester, sampling the transmission frequencies of the cellular base station.

9. The system as claimed in claim 6 further comprising:
providing an RF antenna, attached to the base station tester, for linking a transmitted RF signal as an input signal to the base station tester; and
providing a network analyzer working in conjunction with a digital signal processor, and a protocol analysis block for demodulating the input signal information.

10. The system as claimed in claim 6 further comprising:
providing an RF antenna, attached to the base station tester; and
sampling an RF signal from the passive broadband antenna, attached to the cellular base station, in a non-invasive manner.

11. A wireless network profiling system comprising:
a base station tester for attachment to a cellular base station;
the base station tester comprising a global positioning system and a mobile handset emulator;
the global positioning system used to log the cellular base station position information;
the base station tester used to collect a parametric information from the cellular base station; and
the mobile handset emulator used to transfer the parametric information and position information for analysis and storage.

12. The system as claimed in claim 11 further comprising a spectrum analyzer for frequency spectrum generation to analyze a frequency component of the parametric information.

13. The system as claimed in claim 11 further comprising a digital signal processor to analyze the parametric information based on preset or user defined limits.

14. The system as claimed in claim 11 further comprising a network analyzer used in conjunction with a digital signal processor, and a protocol analysis block to demodulate input signal information.

15. The system as claimed in claim 11 further comprising a radio frequency signal from a passive broadband antenna, attached to the cellular base station, sampled in a non-invasive manner.

16. The system as claimed in claim 11 further comprising:
a passive broadband antenna or a wireless access point attached to the cellular base station; and
a weak component identified prior to failure by the transfer of parametric information through the mobile handset emulator.

17. The system as claimed in claim 16 further comprising a spectrum analyzer wherein the spectrum analyzer is used for frequency analysis of the cellular base station data and commands.

18. The system as claimed in claim 16 further comprising:
a digital signal processor used to analyze the parametric information based on preset or user defined limits;
an RF power monitor allows monitoring of interconnect and transmit power levels; and
an RF antenna, attached to the base station tester, to sample the transmission frequencies of the cellular base station.

19. The system as claimed in claim 16 further comprising:
an RF antenna to link a transmitted RF signal as an input signal to the base station tester; and
a network analyzer used in conjunction with a digital signal processor, and a protocol analysis block to demodulate the input signal information.

20. The system as claimed in claim 16 further comprising:
an RF antenna, attached to the base station tester; and
an RF signal from the passive broadband antenna, attached to the cellular base station, sampled in a non-invasive manner.
